(19) United States
(12) Patent Application Publication
(10) Pub. No.: US 2026/0043993 A1
(43) Pub. Date: Feb. 12, 2026

(54) METHOD AND SYSTEM FOR DETECTING DEFOCUS OF OPTICAL SYSTEM

(71) Applicant: Thermo Electron Scientific Instruments LLC, Madison, WI (US)

(72) Inventor: Francis J. Deck, Madison, WI (US)

(21) Appl. No.: 19/282,510

(22) Filed: Jul. 28, 2025

Related U.S. Application Data
(60) Provisional application No. 63/681,025, filed on Aug. 8, 2024.

(51) Int. Cl. G02B 21/24

(52) U.S. Cl. CPC G02B 21/245

(57) ABSTRACT

In one example, a method for detecting defocus of an optical probe includes obtaining a first sub-image and a second sub-image of an image projected by the optics of the corresponding optical system onto a wavelength-sensitive photodetector in response to a sample region being illuminated with a first light beam of a first wavelength range and a second light beam of a second wavelength range. The first sub-image is formed with light detected by the wavelength-sensitive pixelated photodetector within the first wavelength range. The second sub-image is formed with light detected by the wavelength-sensitive pixelated photodetector within the second wavelength range. The method further includes determining a degree of defocus based on the first sub-image and the second sub-image.

### CROSS-REFERENCE TO RELATED APPLICATIONS

This application claims the benefit of U.S. Provisional Patent Application No. 63/681,025 filed on Aug. 8, 2024, the contents of which are incorporated herein by reference.

### TECHNICAL FIELD

Various examples relate generally, but not exclusively, to methods and systems for detecting defocus in an optical microscope or probe.

### BACKGROUND

Autofocus is an important function for an optical microscope where refocusing may be needed, e.g., when the field of view is being changed during imaging. For example, in FTIR (Fourier Transform Infrared) spectroscopy, infrared light is passed through a sample, and the intensity of the transmitted or absorbed light is measured. To achieve optimal results, the infrared beam needs to be focused precisely on the sample surface. It is particularly important when analyzing samples with uneven or non-flat surfaces, as it ensures that the infrared beam is focused properly, regardless of the sample's characteristics. In another example, multi-well plates are typically not flat, with the feature-height variation across the plate typically exceeding 100 μm. During unsupervised (automated) scanning and imaging of a multi-well plate, the autofocus function is used to bring each well into focus before an image of the well is acquired. Another example application of the autofocus function is associated with imaging modalities involving extended image-data acquisition times, such as the time-lapse microscopy or single-molecule localization microscopy. There are many other use cases for the autofocus function of an optical microscope or probe. Hence, development of effective devices, methods, and software to detect the loss of focus that are applicable to a range of use cases is of great practical importance to the field of optical imaging.

### SUMMARY

In one example, an optical system comprises: a wavelength-sensitive photodetector; a light source configured to output a first light beam of a first wavelength range and a second light beam of a second wavelength range; optics configured to illuminate a portion of a sample with the first and second light beams from different directions of incidence and project an image of at least a part of the illuminated portion of the sample onto the wavelength-sensitive photodetector; and a computing device including a non-transitory computer-readable medium for storing instructions and an electronic processor, wherein by executing the instructions with the processor, the computing device is configured to determine a degree of defocus based on a first sub-image of the projected image and a second sub-image of the projected image, the first sub-image being formed with light within the first wavelength range detected by the wavelength-sensitive photodetector, the second sub-image being formed with light within the second wavelength range detected by the wavelength-sensitive photodetector.

In another example, a method for providing support to an optical system comprises: generating a first light beam of a first wavelength range and a second light beam of a second wavelength range; illuminating a sample portion with the first light beam and the second light beam from different directions of incidence; projecting an image of at least a part of the illuminated sample portion onto a wavelength-sensitive photodetector; obtaining a first sub-image and a second sub-image from the image detected by the wavelength-sensitive photodetector, wherein the first sub-image is formed with light within the first wavelength range, and wherein the second sub-image is formed with light within the second wavelength range; and determining a degree of defocus based on the first sub-image and the second sub-image.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings.

FIG. 1 is a block diagram illustrating an optical system in which at least some embodiments can be practiced.

FIG. 2 is a schematic diagram illustrating an optical microscope used in the optical system of FIG. 1 according to some examples.

FIG. 3A is schematic diagram illustrating the optics used in the optical microscope of FIG. 2 according to some examples.

FIG. 3B is a schematic diagram illustrating the optics used in the optical microscope of FIG. 2 according to some additional examples.

FIGS. 4A-4C show schematic plan views of optical filters used with the optics illustrated in FIG. 3 according to some examples.

FIG. 5 is a schematic diagram illustrating a pixelated photodetector used in the optical microscope of FIG. 2 according to some examples.

FIG. 6 graphically illustrates relative spectral characteristics of an optical filter and the pixelated photodetector used in the optical microscope of FIG. 2 according to some examples.

FIG. 7 is a flowchart illustrating a method of calibrating an autofocus function in the optical system of FIG. 1 according to some examples.

FIG. 8 illustrates a calibration graph constructed using the method of FIG. 7 according to one example.

FIG. 9 is a flowchart of an autofocus method implemented in the optical system of FIG. 1 according to some examples.

FIG. 10 is a block diagram illustrating a plan view of a multicolor LED assembly used in the optical microscope of FIG. 2 according to some examples.

FIG. 11 graphically illustrates spectral characteristics of the multicolor LED assembly of FIG. 10 according to one example.

FIG. 12 is a block diagram illustrating another optical system in which at least some embodiments can be practiced.

FIG. 13 is a block diagram illustrating a computing device used in the optical system of FIG. 1 or the spectrometer of FIG. 12 according to some examples.

### DETAILED DESCRIPTION

An example autofocus system operates to determine the degree of defocus and typically has an actuator to move either the sample or the objective lens to bring the corresponding microscope or optical probe back into focus. In general, autofocus approaches can be categorized as passive or active. An active autofocus system measures the distance to the specimen (or sample) independently of the optical imaging system and subsequently adjusts one or more elements in the optical imaging system to achieve the correct focus based on the measured distance. In some examples, an active autofocus system irradiates the specimen with infrared light from a dedicated autofocus light source and adjusts the focal plane of the imaging optics relative to the sample based on a returned portion of the infrared light. A passive autofocus system determines the correct focus based on passive analyses of one or more images that are captured with the optical imaging system. Passive autofocus systems do not generally direct any additional energy, such as ultrasound or infrared light, toward the specimen. In some examples, passive autofocusing is achieved via phase detection or contrast measurements in the one or more images.

Herein, a degree of defocus is passively determined based on sub-images formed with detected light in different wavelength ranges. The sub-images are obtained from an image of the sample illuminated by a first light beam of a first wavelength range and a second light beam of a second wavelength range. The first and second light beams are generated by a light source and may be spatially separated when entering the optics configured to direct the light beams towards the sample. The imaging optics direct the first and second light beams towards the sample from different respective angles or directions of incidence. The imaging optics includes an objective. In some examples, the degree of defocus is a measure of the degree of axial displacement of the specimen/sample from the focal plane of the imaging optics. The degree of defocus may be represented by one or more of a displacement magnitude and a displacement direction. The sub-images include a first sub-image and a second sub-image, wherein the first sub-image is formed with light detected within the first wavelength range, and the second sub-image is formed with light detected within the second wavelength range. In some examples, the first wavelength range and the second wavelength range overlap for less than 50 nm. In some other examples, the first wavelength range and the second wavelength range do not overlap.

The first and second light beams spatially overlap in an illuminated portion/region of the sample. As such, features in the same sample region (illuminated portion) may be imaged in both the first and the second wavelength ranges. The first and second wavelength ranges may both be in the visible wavelength range. For example, the first wavelength range may correspond to red light, and the second wavelength range may correspond to blue light. When the specimen is in focus, the first and second light beams overlap, and the corresponding colors mix at the specimen such that the camera captures a color image as if the specimen was illuminated by spatially homogeneous white light. In other words, the sub-images (for example in red and blue colors, respectively) spatially overlap. When the specimen is out of focus, the features of the specimen in the red and blue colors (or the red sub-image and the blue sub-image) of the color image formed on the pixelated photodetector of the camera become laterally shifted relative to one another. The magnitude of the lateral shift is approximately proportional to the degree of axial displacement of the specimen from the focal plane of the imaging optics and may be used as a defocus value (e.g., the degree of defocus) for driving the focus adjustment mechanism. The degree of defocus may include a sign indicating the direction of the shift between the two sub-images.

In some examples, the relative position between the sample and the focal plane of the imaging optics may be adjusted based on the degree of defocus. For example, one or more actuators and/or adjustable elements may be coupled to the optics and/or the sample stage to adjust the relative position. The actuators and adjustable elements may drive the specimen and/or the focal plane of the imaging optics toward their mutual alignment.

In one example, an optical system for autofocusing may include a wavelength-sensitive pixelated photodetector, a light source configured to output the first light beam and the second light beam, the first light beam and the second light beam being spatially separated, optics configured to illuminate the sample with the first and second light beams and project an image of an illuminated portion of the sample onto the wavelength-sensitive pixelated photodetector, and a computing device configured to determine the degree of defocus based on the first sub-image and the second sub-image of the projected image. In some examples, the optical system may be a part of a larger spectroscopy system, such as a spectroscopy system interrogating the sample in the NIR and/or IR wavelength range. In one example, the spectroscopy system may be an FTIR spectroscopy system. The optical system may automatically detect or correct the focus without interfering with the normal use of the spectroscopy system.

The light source outputs the first and second light beams traveling along different respective optical paths when exiting the light source. In one example, the light source includes a broadband source and an optical filter configured to filter the light generated by the broadband source to produce the first light beam and the second light beam. In another example, the light source includes multiple multicolor light emitting diode (LED) panels. For example, the light source may include a first LED emitting the first light beam and a second LED emitting the second light beam.

In one example, the light source includes an aperture stop, and the first and second light beams exit the light source at the aperture stop. The aperture stop is configured such that the first and second light beams are spatially separated at the aperture stop. For example, the aperture stop may be divided into portions allowing light of different respective colors to pass through. In some examples, the optical filer may function as the aperture stop. In some other examples, the aperture stop may be virtual. The optical system may include an objective configured to focus light to the focal plane of the optics. The aperture stop is imaged to the aperture of the objective such that different colors of light enter the objective at different portions of the objective aperture. In some examples, the light source generates the first and second light beams that travel along different respective trajectories along the optical axis.

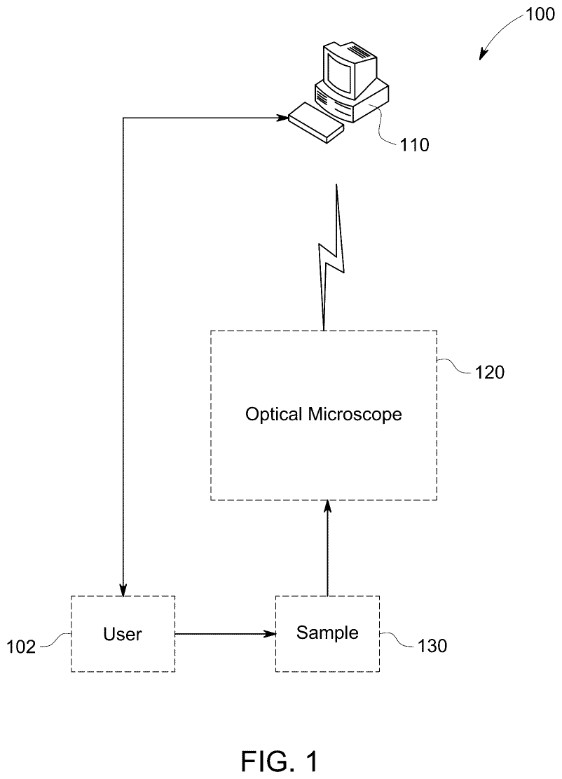

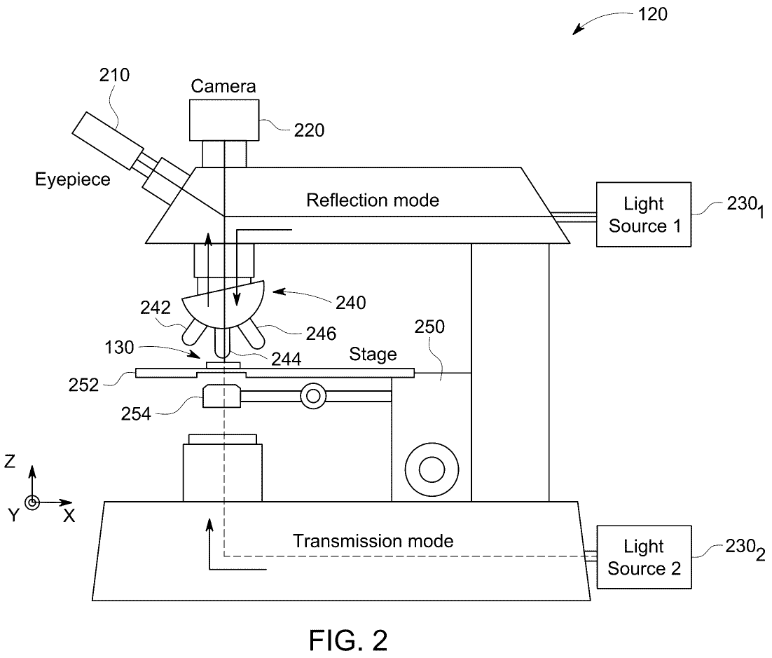

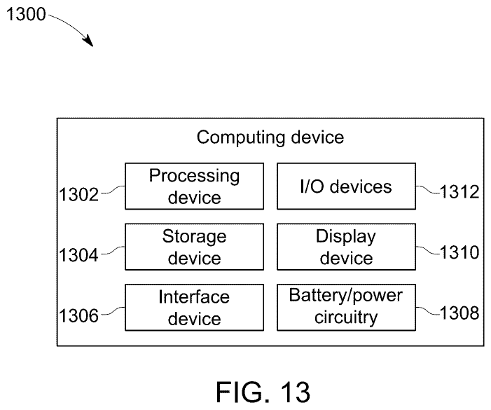

FIG. 1 is a block diagram illustrating an optical system 100 in which at least some embodiments can be practiced. The optical system 100 includes an analytical optical microscope 120 and a computing device 110 for providing support to the microscope. A user 102 can load a sample 130 into the optical microscope 120 and interact with the computing device 110 to obtain images of the sample 130. Example functions of the computing device 110 include (i) various microscope control functions, including the above-mentioned autofocus function; (ii) image processing functions; and (iii) user interface functions. An example computing device that can be used to implement the computing device 110 is described in more detail below in reference to FIG. 13. An example of the optical microscope 120 is described in more detail below in reference to FIGS. 2-6.

FIG. 2 is a schematic diagram illustrating the optical microscope 120 according to one example. In the example shown, the optical microscope 120 is configured to support two illumination modes, i.e., a reflection mode and a transmission mode. Reflected illumination is typically recommended for visualizing opaque and relatively thick samples, whereas transmitted illumination is typically recommended for specimens that are substantially transparent and relatively thin. This dual illumination capability beneficially enables the optical microscope 120 to accommodate a range of samples with widely varying optical properties, e.g., ranging from opaque semiconductor chips to semi-transparent tissue cultures. One of the reflection and transmission modes can be selected by the user 102 depending on the specific sample 130.

The optical microscope 120 includes light sources 230₁, 230₂ configured to illuminate the sample 130 in the reflection and transmission modes, respectively. The sample 130 is mounted on a support table or sample holder 252 that is coupled to a controlled actuation system 250, often referred to as “stage.” In various examples, the stage 250 is configured to independently move the sample holder 252 parallel to the XY-coordinate plane and parallel to the Z-coordinate axis, with the corresponding coordinate system being indicated by the XYZ-coordinate triad shown in FIG. 2. In some examples, movements of the stage 250 are controlled by or via the computing device 110 (FIG. 1).

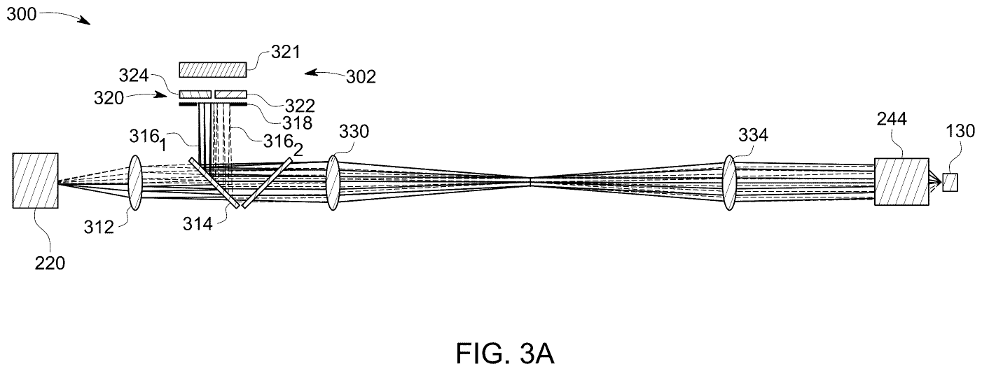

The optical microscope 120 also includes a plurality of objectives 242, 244, 246 mounted on an objective turret 240. Different ones of the objectives 242, 244, 246 can be selected by the user 102 by rotating the turret 240 to achieve different respective magnifications of the sample 130. In the example shown, the objective lens 244 is selected. A magnified image of the sample 130 is projected by the imaging optics (not explicitly shown in FIG. 2; see, e.g., FIG. 3B) of the optical microscope 120 onto a pixelated photodetector of a camera 220 and can also be viewed by the user 102 through an eyepiece 210. Readout signals from the pixelated photodetector of the camera 220 are typically directed to the computing device 110 (FIG. 1), where the readout signals can be processed and displayed as images for the user 102.

For illustration purposes and without any implied limitations, various autofocus features of the optical system 100 are described below in reference to the reflected illumination mode of the optical microscope 120. However, various embodiments are not so limited. Based on the provided description, a person of ordinary skill in the pertinent art will be able to also implement automatic focusing for the transmitted illumination mode of the optical microscope 120 without any undue experimentation.

FIG. 3A is schematic diagram illustrating optics 300 used in the optical microscope 120 according to some examples. The optics 300 may be optically coupled to a light source 302, the camera 220, the objective 244, and the sample 130 (also see FIG. 2). For clarity of depiction, optical elements corresponding to the eyepiece 210 are not explicitly shown in FIG. 3A. For illustration purposes, the ray diagram shown in FIG. 3A represents a nearly in-focus state of the optical microscope 120 with respect to the sample 130.

In the example shown, the light source 302 includes an illuminator 321, an optical filter 320, and an aperture stop 318. In some examples, the illuminator 321 may include an LED illuminator. The optical filter 320 is placed at the aperture stop 318 and configured to filter the light emitted by the illuminator 321, thereby producing output optical beams 316₁ and 316₂ carrying light corresponding to different respective wavelength ranges. In other examples, other suitable locations for the optical filter 320 can also be used. The light beams 316₁ and 316₂ are inserted into a main beam path of the optics 300 by a beamsplitter 314. The aperture stop 318 is imaged to the aperture of the objective 244 by a 4f relay system including lenses 330 and 334. In the example shown, lenses 330 and 334 have the same focal length f, which is equal to one quarter of the optical path length from the aperture stop 318 to the aperture of the objective 244.

In some examples, the illuminator 321 emits substantially “white” light that includes red (R), green (G), and blue (B) spectral components. According to one example, the R spectral component includes light spectrally located in the wavelength range between approximately 610 nm and approximately 700 nm; the G spectral component includes light spectrally located in the wavelength range between approximately 500 nm and 570 nm; and the B spectral component includes light spectrally located in the wavelength range between approximately 430 nm and 485 nm. When properly balanced in intensity, the R, G, and B spectral components combine to form a perceptually “white” color. While many different color combinations may be registered as “white” with a human eye or with a wavelength-sensitive photodetector, the “daylight white” may typically be used as a reference for what constitutes the perceptually white color and be modeled with a black-body emitter having the temperature of approximately 6000 K.

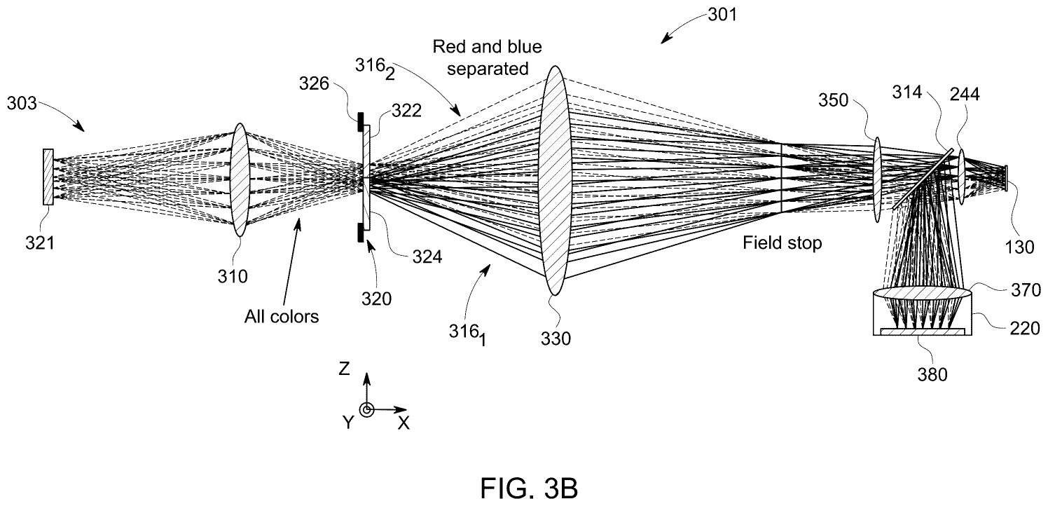

The ray diagram shown in FIG. 3A traces the propagation, through the optics 300, of the R and B components emitted by the illuminator 321. The optical filter 320 has two differently colored portions (tiles), which are labeled using the reference numerals 322 and 324, respectively. Several examples of the optical filter 320 including the portions 322, 324 are described in more detail below in reference to FIGS. 4A-4C. In some examples, the portion 322 is predominantly blue in color and, as such, attenuates or substantially blocks the R component of the emitted white light. The portion 324 is predominantly red in color and, as such, attenuates or substantially blocks the B component of the emitted white light.

The filtered light beams 316₁ and 316₂ produced by the optical filter 320 are partially reflected by the beam splitter 314 toward the sample 130 and then impinge on the sample 130 after passing through the lenses 330, 334 and the objective 244. A portion of the light reflected from the sample 130 is collected by the objective 244, and the collected light is directed through the lenses 330, 334 back toward the beam splitter 314. A fraction of the collected light passes through the beam splitter 314 and impinges on a pixelated photodetector of the camera 220 after passing through a camera lens 312.

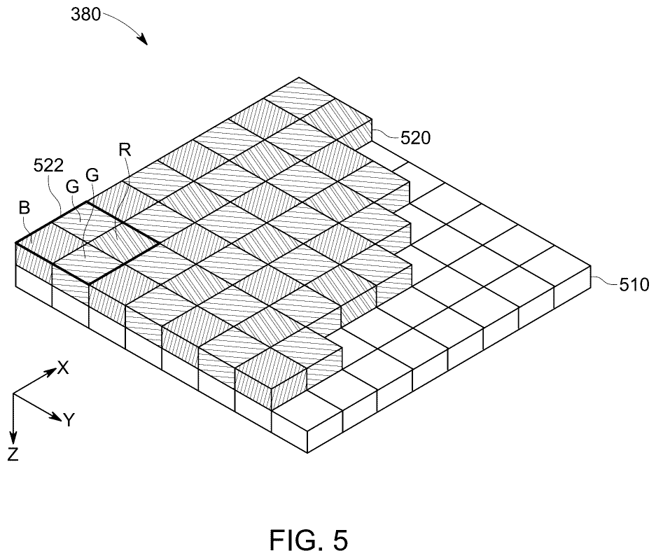

In some examples, the spectral characteristics of the portions 322, 324 of the optical filter 320 are selected based on the spectral sensitivity curves of the pixelated photodetector of the camera 220, e.g., as described in more detail below in reference to FIG. 6. Due to the filter portions 322, 324 being located in different respective nonoverlapping areas of the optical filter 320, the R and B spectral components of the light emitted by the light source 302 take different respective effective optical paths through the optics 300 before they can reach the pixelated photodetector of the camera 220, which creates sensitivity to the state of alignment of the optics 300 observable with the camera 220. More specifically, when the sample 130 is in good focus for being imaged by the lenses 312, 330, 334, 244 onto the pixelated photodetector of the camera 220, there is substantially no phase separation between the colors, and the sub-images of the sample 130 corresponding to different colors will coincide at the pixelated photodetector. In contrast, when the sample 130 is out of focus, the spatial separation of the portions 322, 324 in the optical filter 320 will cause noticeable phase separation between the colors, and the sub-images of the sample 130 corresponding to different colors will be shifted with respect to one another on the pixelated photodetector of the camera 220. This relative shift can be detected and quantified, e.g., as described in more detail below in reference to Eqs. (1)-(5). When the sample 130 is nearly in focus, the sample 130 will appear in the corresponding captured color image as being illuminated with white light, thus beneficially allowing simultaneous autofocusing and substantially true-color sample observation and/or imaging.

In one example, a schematic diagram illustrating the optics used in the optical microscope 120 for the transmission mode can be obtained by: (i) changing the position of the illuminator to the mirror image of the position shown in FIG. 3A with respect to the main plane of the sample 130 and (ii) adding a condenser lens 254 in the position indicated in FIG. 2. A person of ordinary skill in the pertinent art will readily understand that various features of the autofocus function of the optical microscope 120 described below in reference to the reflection mode are applicable, mutatis mutandis, to the transmission mode as well.

FIG. 3B is schematic diagram illustrating optics 301 used in the optical microscope 120 according to some additional examples. The optics 301 is shown as being optically coupled to a light source 303, the camera 220, the objective 244, and the sample 130 (also see FIG. 2). For clarity of depiction, optical elements corresponding to the eyepiece 210 are not explicitly shown in FIG. 3B. For illustration purposes, the ray diagram shown in FIG. 3B represents a nearly in-focus state of the optical microscope 120 with respect to the sample 130.

The optics 301 has some elements that are similar to the corresponding elements of the optics 300. These elements are labeled in FIG. 3B with the same reference numerals as in FIG. 3A.

The light source 303 includes the illuminator 321, a collector lens 310, and the optical filter 320. The collector lens 310 is configured to beamform the light emitted by the illuminator 321 and direct the beamformed light to the optical filter 320. In some examples, the optical filter 320 is placed at the aperture stop (not explicitly shown in FIG. 3B) of the light source 303. In some examples, the optical filter 320 can serve as the aperture stop. In some examples, the optical filter 320 is located in a Fourier plane between the collector lens 310 and an auxiliary tube lens 330. In other examples, other suitable locations for the optical filter 320 can also be used.

The filtered light beams 316₁ and 316₂ produced by the optical filter 320 pass through the auxiliary tube lens 330, a second tube lens 350, and the beam splitter 314 and then impinge on the sample 130 from different directions and/or angles of incidence after passing through the objective lens 244. The filtered light beams 316₁ and 316₂ enter objective lens 244 from different portions of the objective lens. A portion of the light reflected from the sample 130 is collected by the objective lens 244, and the collected light is directed back toward the beam splitter 314. A fraction of the collected light is reflected by the beam splitter 314 towards the camera 220 and then impinges on a pixelated photodetector 380 of the camera 220 after passing through a camera lens 370.

When the sample 130 is in good focus for being imaged by the lenses 244, 370 onto the pixelated photodetector 380, there is substantially no phase separation between the colors, and the sub-images of the sample 130 corresponding to different colors will coincide at the pixelated photodetector 380 as schematically indicated in FIG. 3B by the coincidence of the R and B rays at different pixels across the photodetector. In contrast, when the sample 130 is out of focus, the spatial separation of the portions 322, 324 in the optical filter 320 will cause noticeable phase separation between the colors, and the sub-images of the sample 130 corresponding to different colors will be shifted with respect to one another on the pixelated photodetector 380. This relative shift can be detected and quantified, e.g., as described in more detail below in reference to Eqs. (1)-(5). When the sample 130 is nearly in focus, the sample 130 will appear in the corresponding captured color image as being illuminated with white light, thus beneficially allowing simultaneous autofocusing and substantially true-color sample observation and/or imaging.

FIGS. 4A-4C illustrate plan views of the optical filter 320 used in the optics 300, 301 according to various examples. Although the illustrated examples of the optical filter 320 employ patterns formed exclusively from R, G, B, and colorless (CL) tiles, various embodiments are not so limited. For example, in some cases, the optical filter 320 can be constructed using other combinations of colored tiles, e.g., including but not limited to cyan, yellow, magenta, and/or emerald tiles. In general, the color choices for the portions of the optical filter 320 may depend on the types and patterns of the color pixels used in the pixelated photodetector 380 of the camera 220.

In the example shown in FIG. 4A, the optical filter 320 is a partially transparent glass plate or slide that has exactly two rectangular portions 322, 324 located side by side to one another, with each occupying a respective half of the total filter area. In some examples, the optical filter 320 is superimposed with a circular aperture 402 that changes the effective shape of the filter to a circular shape by clipping each of the rectangular portions 322, 324 to a respective semicircular shape. All light that falls on the optical filter 320 outside the circular aperture 402 is blocked from propagating through the filter.

In the example shown in FIG. 4B, the optical filter 320 has a CL portion 404 in addition to the colored portions 322, 324. The CL portion 404 has a rectangular shape and is connected between the facing edges of the rectangular portions 322, 324. Different examples of the CL portion 404 may have different respective widths, w. In some examples, the CL portion 404 is replaced by a green (G) portion of the same shape.

In the example shown in FIG. 4C, the optical filter 320 has green portions 406, 408 in addition to the blue portion 322 and the red portion 324. The colored portions 322, 324, 406, 408 are arranged in a basic Bayer pattern. In the example shown, the colored portions 322, 324, 406, 408 have identical rectangular shapes. In some examples, one of the green portions 406, 408 can be replaced by a CL portion of the same shape.

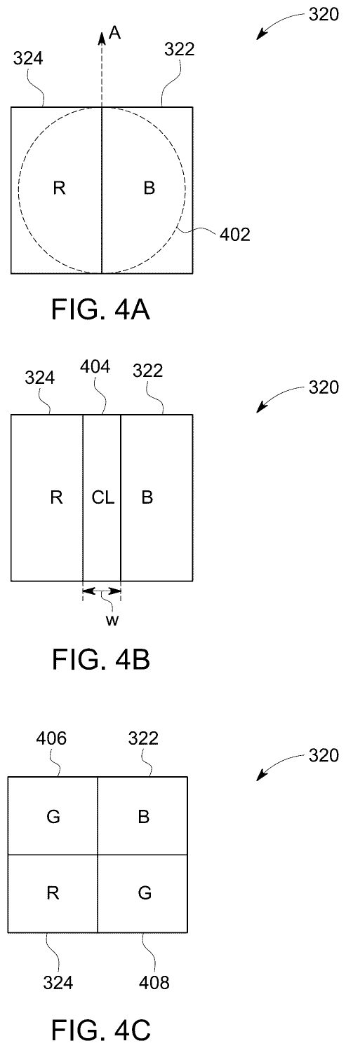

FIG. 5 is a schematic diagram illustrating the pixelated photodetector 380 according to some examples. In the example shown, the pixelated photodetector 380 includes a device layer 510 and a filter layer 520. Each pixel of the device layer 510 includes a respective individual photodetector, e.g., a photodiode. The filter layer includes a mosaic of R, G, and B filters arranged in a periodic pattern. In the example shown, a kernel 522 of the periodic pattern includes four filters arranged in a basic Bayer pattern, with each of the four filters being overlaid on a respective individual photodetector of the device layer 510. In other examples, other kernels can also be used to implement the filter layer 520.

FIG. 6 graphically illustrates relative spectral characteristics of the optical filter 320 and the pixelated photodetector 380 used in the optical microscope 120 according to some examples. More specifically, spectral response curves 602, 604, and 606 shown in FIG. 6 represent the light conversion efficiency (quantum yield) of the R, G, and B pixels, respectively, of the pixelated photodetector 380 illustrated in FIG. 5. In this particular example, the corresponding camera 220 is an instance of the commercially available Basler daA2500-14uc (S-Mount) camera. The pixelated photodetector 380 used in this camera is an Onsemi Model MT9P031 CMOS sensor configured to deliver 14 frames per second at 5 MP resolution. The physical size of the pixel array in this CMOS sensor is 1×2.5 inch². A significant overlap between the spectral response curves 602, 604, and 606 can be noted. Of particular importance to at least some examples described herein is the spectral intersection point between the R-pixel spectral response curve 602 and the B-pixel spectral response curve 606. The spectral location (wavelength) of this intersection point is denoted as λ₀. In the example shown, the wavelength λ₀ is approximately 550 nm. The value of the wavelength λ₀ may typically depend on the model of the camera 220 and/or the model of the pixelated photodetector 380 used therein.

Spectral transmission curves 622 and 624 represent transmission characteristics of the portions 322 and 324, respectively, of the optical filter 320 (also see FIGS. 3A-3B). In the example shown, the portion 322 acts as a short-pass optical filter in the visible range, whereas the portion 324 acts as a long-pass optical filter in the visible range. Both of the portions 322, 324 also act as infrared blocking filters that substantially prevent any infrared light emitted by the light source from reaching the sample 130 and the pixelated photodetector 380.

A short-pass filter is typically characterized by its cut-off wavelength. Herein, such cut-off wavelength is defined as the wavelength corresponding to one half of the maximum transmission of the short-pass filter at the long-wavelength spectral edge thereof. A long-pass filter is typically characterized by its cut-on wavelength. Herein, such cut-on wavelength is defined as the wavelength corresponding to one half of the maximum transmission of the long-pass filter at the short-wavelength spectral edge thereof. A large variety of short-pass and long-pass filters having various values of the cut-off and cut-on wavelengths is commercially available, e.g., from Thorlabs, Inc. and its competitors.

In some examples, the cut-off wavelength of the portion 322 is spectrally aligned with the wavelength λ₀ of the pixelated photodetector 380 to within 20 nm, 10 nm, 5 nm, or 1 nm. In some other examples, the cut-on wavelength of the portion 324 is spectrally aligned with the wavelength λ₀ of the pixelated photodetector 380 to within 20 nm, 10 nm, 5 nm, or 1 nm. In yet some other examples, the cut-off wavelength of the portion 322 is spectrally aligned with the cut-on wavelength of the portion 324 to within 10 nm, 5 nm, or 1 nm. In some examples, it is preferred that each of the cut-off wavelength of the portion 322 and the cut-on wavelength of the portion 324 is spectrally aligned with the wavelength λ₀ of the pixelated photodetector 380 to within 10 nm, 5 nm, or 1 nm. Such spectral alignment beneficially enables the pixelated photodetector 380 to capture substantially true-color images of the sample 130 when the optics 300 or 301 is nearly in focus.

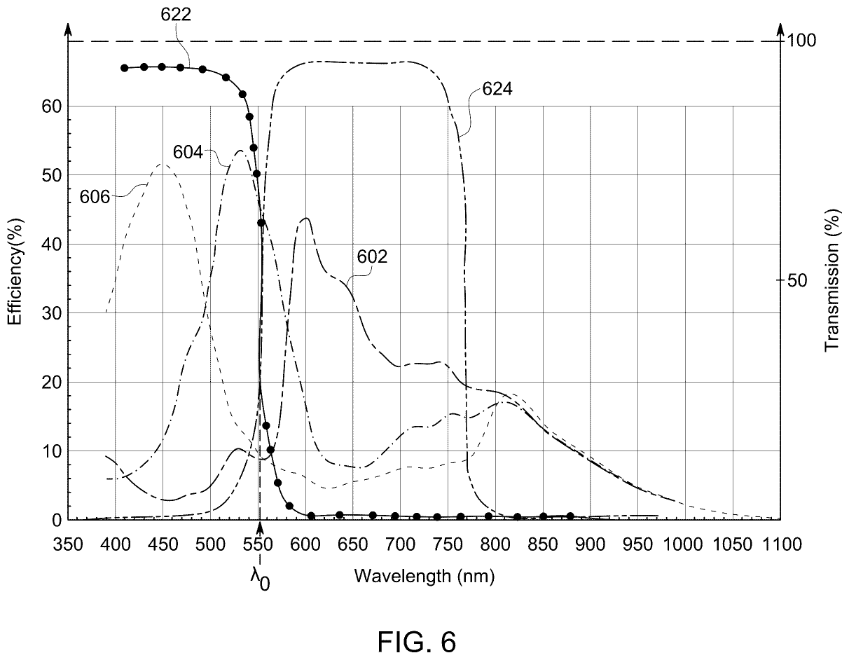

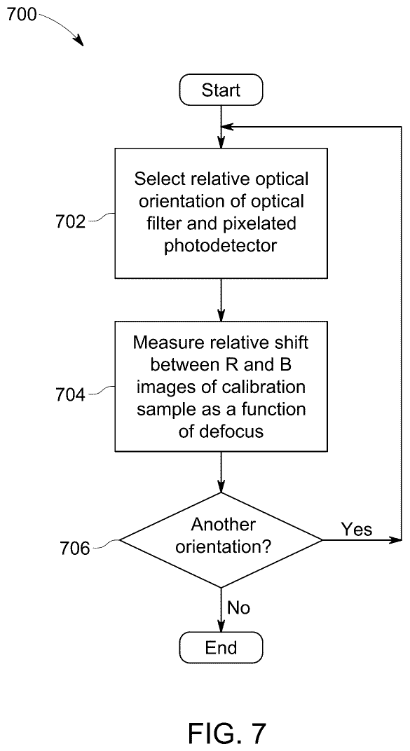

FIG. 7 is a flowchart illustrating a method 700 of determining defocus in an optical system (such as the optical system 100) according to some examples. For the method 700, a calibration sample can be used as the sample 130. In some examples, the calibration sample 130 has a multidimensional, substantially non-periodic pattern including a plurality of features that exhibit relatively strong contrast when illuminated by visible light. Various calibration samples that can be used as the calibration sample 130 in the method 700 are described, e.g., in U.S. Pat. No. 10,846,882, which is incorporated herein by reference in its entirety. The method 700 is described below with continued reference to FIGS. 1-7 and with further reference to FIG. 8.

The method 700 includes selecting relative axial optical orientation of the optical filter 320 and the pixelated photodetector 380 (in a block 702). Such relative axial optical orientation can be changed by rotating the filter 320 about the X-coordinate axis and/or rotating the camera 220 about the Z-coordinate axis (also see FIG. 3B). Since the pixelated photodetector 380 is fixedly mounted in the housing of the camera 220, rotation of the camera 220 about the Z-coordinate axis will cause the corresponding rotation of the pixelated photodetector 380 about the Z-coordinate axis.

Since neither the kernel 522 of the pixelated photodetector 380 nor the tile pattern of the filter 320 is axially symmetric with respect to the respective “normal” direction (i.e., the direction orthogonal to the main plane thereof), the relative axial orientation of the pixelated photodetector 380 and the filter 320 affects the magnitude of the observed lateral shift between the red and blue sub-images. For example, for the same degree of defocus, one relative axial orientation of the pixelated photodetector 380 and the filter 320 may result in a relatively small observed lateral shift between the red and blue sub-images, whereas another relative axial orientation of the pixelated photodetector 380 and the filter 320 may result in a relatively large observed lateral shift between the red and blue sub-images. Moreover, for some relative axial orientations of the pixelated photodetector 380 and the filter 320, the observed lateral shift between the red and blue sub-images may be close to zero for any degree of defocus. Therefore, it may be advantageous to find a relative axial orientation of the pixelated photodetector 380 and the filter 320 that substantially maximizes the observed lateral shift between the red and blue sub-images for various degrees of defocus. When the pixelated photodetector 380 and the filter 320 have such relative axial orientation, the corresponding autofocus function will beneficially have approximately highest possible sensitivity to defocus.

Herein, a “main plane” of an object, such as a plate, a die, a substrate, or an IC, is a plane parallel to a substantially planar surface thereof that has about the largest area among exterior surfaces of the object. This substantially planar surface may be referred to as a main surface. The exterior surfaces of the object that have one relatively large size, e.g., length, but are of much smaller area, e.g., less than one half of the main-surface area, are typically referred to as the edges of the object.

For illustration purposes and without any implied limitations, the method 700 is described in reference to a configuration in which the camera 220 is affixed to the body of the microscope 120 to produce the orientation of the pixelated photodetector 380 indicated by the XYZ-coordinate triad shown in FIG. 5. Note that the XYZ-coordinate triads shown in FIGS. 2, 3B, and 5 represent the same Cartesian coordinate system. In this configuration, a change in the relative axial optical orientation of the optical filter 320 and the pixelated photodetector 380 in the block 702 is achieved by rotating the optical filter 320 about the X-coordinate axis (also see FIG. 3B). Such rotation causes an angle change between the orientation vector A of the optical filter 320 shown in FIG. 4A and the Z-coordinate axis (also see FIG. 3B).

In the method 700, the block 702 is a part of a processing loop 702-706. Several different orientations of the optical filter 320 are typically selected in different instances of the block 702 as the method 700 repeats the processing loop 702-706. In one example, for the first instance of the block 702, the optical filter 320 is oriented such that the filter orientation vector A is parallel to the Z-coordinate axis (also see FIGS. 3B and 4A). In other examples, other initial orientations of the filter orientation vector A can alternatively be selected. For each subsequent instance of the block 702, the optical filter 320 is incrementally rotated about the X-coordinate axis by a fixed angle, e.g., in the clockwise direction, until a desired angular range is sampled. In one example, the angle increment is 15 degrees, and the angular range is 180 degrees. In other examples, other values of the angle increment and angular range can also be used. In some examples, the optical filter 320 is mounted on a motorized rotation stage 326 (FIG. 3B) that performs the incremental rotations of the filter in response to a corresponding control signal received from the computing device 110.

The method 700 also includes illuminating a portion of the calibration sample 130 with both the first and second light beams and determining the relative shift between the detected R and B images of the calibration sample 130 (in the block 704). Herein, the R image is the sub-image of the calibration sample 130 captured by the R pixels of the pixelated photodetector 380 (also see FIG. 5). The B image is the sub-image of the calibration sample 130 captured by the B pixels of the pixelated photodetector 380 (also see FIG. 5).

In some examples, the defocus value is changed in the block 704 by operating a corresponding translation stage (e.g., the stage 250, FIG. 2) to incrementally translate the calibration sample 130 or the objective 244 along the pertinent optical axis (e.g., along the X-coordinate axis in the optics 301, FIG. 3B). In one example, the initial position of the translation stage causes a relatively large underfocus of the sample 130, and the final position of the translation stage causes a relatively large overfocus of the sample 130. The translation increment is selected to sufficiently sample the intermediate range between the initial position and the final position. At each sampling location along the optical axis, the camera 220 is operated to capture a respective color image of the calibration sample 130.

Operations of the block 704 also include several image processing operations performed via the computing device 110. First, for each image of the calibration sample 130 captured as described above, a respective pair of R and B sub-images of the calibration sample 130 is read out by selectively addressing the R pixels and the B pixels, respectively, of the pixelated photodetector 380. Such pair of R and B sub-images is then subjected to cross-correlation analysis to determine the corresponding value of the shift vector (Δx, Δy) describing the relative positions of these sub-images on the pixelated photodetector 380.

In some examples, for a pair of R and B sub-images r and b, the cross-correlation analysis of the block 704 includes the following example operations. First, Fourier transforms R and B of the sub-images r and b are computed as expressed by Eqs. (1)-(2):

$$R = FFT \{ r \} \qquad ( 1 )$$

$$B = FFT \{ b \} \qquad ( 2 )$$

where FFT denotes the fast Fourier transform operation. Next, a correlogram, C, is computed as follows:

$$C = R ∘ {B}^{*} \qquad ( 3 )$$

where ∘ denotes the Hadamard product; and * denotes the complex conjugate. In some examples, an optional Fourier filtering operation can be added in the computation of C to achieve a bandpass filtering behavior by suppressing the contribution of low and high spatial frequencies. Then, a cross-correlation image, c, is obtained by applying an inverse Fourier transform to the correlogram C:

$$c = IFFT \{ C \} \qquad ( 4 )$$

where IFFT denotes the inverse fast Fourier transform operation. Finally, the shift vector (Δx, Δy) is determined by finding the coordinates of the maximum cᵢⱼ in the cross-correlation image c as follows:

$$( Δ x , Δ y ) = {arg max}_{( i , j )} \{ c \} \qquad ( 5 )$$

where i and j are the pixel indices corresponding to the X and Y coordinates, respectively. In some examples, a model function is optionally fit to the peak in the cross-correlation image to obtain sub-pixel localization accuracy. The operations expressed by Eqs. (1)-(5) are repeated for different pairs of sub-images r and b corresponding to different positions of the translation stage. The sequence of shift vectors (Δx, Δy) obtained in this manner is then used to construct a respective calibration graph, an example of which as described in more detail below in reference to FIG. 8.

In other examples, the block 704 may be configured to use other suitable image registration, correlation, and/or tracking techniques to determine the sequence of shift vectors (Δx, Δy) corresponding to different defocus values. The block 704 may determine the degree of defocus based on the relative shift between the R and B images. In some examples, the degree of defocus may be represented by the relative shift between the sub-images. In some examples, the degree of defocus may be represented by the deviation of the captured image from the focal plane of the optics.

The method 700 also includes determining (in the decision block 706) whether another relative optical orientation of the optical filter 320 and the pixelated photodetector 380 needs to be characterized. In some examples, this determination is made in the decision block 706 based on whether or not the desired angular range has been sufficiently sampled with the previously completed instances of the loop 702-706. For example, when the angle increment is 15 degrees and the angular range to be sampled is 180 degrees, the angular range may be deemed to have been sufficiently sampled (“No” at the decision block 706) after the measurements corresponding to each of thirteen different angles (e.g., 0, 15, 30, 45, 60, 75, 90, 105, 120, 135, 150, 165, and 180 degrees) of the angular range have been completed. When measurements corresponding to at least one of the thirteen angles are not yet completed (“Yes” at the decision block 706), the corresponding measurements will continue by repeating the processing loop 702-706 for one of the unevaluated angles. When it is determined in this manner that another relative optical orientation of the optical filter 320 and the pixelated photodetector 380 needs to be characterized (“Yes” at the decision block 706), the processing of the method 700 is directed back to the block 702. When it is determined that all intended relative orientations have been characterized (“No” at the decision block 706), the processing of the method 700 is terminated.

FIG. 8 illustrates a calibration graph 800 constructed in a single instance of the block 704 of the method 700 according to one example. The calibration graph 800 was obtained by adjusting the Z position of the stage 250 and measuring the pixel shifts in the X and Y directions between the R and B sub-images at each Z position. The calibration graph 800 includes two plots, which are labeled using the reference numerals 802 and 804, respectively. The plot 802 shows the Δx component of the image shift vector as a function of defocus. The plot 804 similarly shows the Δy component of the image shift vector as a function of defocus. In some examples, the position of the “zero” defocus value on the abscissa axis of the calibration graph 800 is obtained by applying a conventional contrast quantification method to the sequence of color images of the calibration sample 130 captured during the block 704 as described above. More specifically, the position of the stage 250 corresponding to the maximum contrast value in the sequence of color images is determined with such contrast quantification method and is assigned the “zero” defocus value on the abscissa axis of the calibration graph 800. The Δx and Δy components of the image shift vector are then plotted with respect to that abscissa axis. Due to the layout of the RGB kernel 522 in the pixelated detector 380 and the specific relative axial orientation of the filter 320 and the detector, the point representing zero defocus in FIG. 8 does not coincide with the crossing of the plots 802 and 804 (zero image shift).

Note that, although contrast-based focusing of imaging optics works well for calibration samples, it oftentimes has insufficient accuracy or completely breaks down for real-life samples in which a sufficient number of strong contrast features may not be present. In addition, contrast-based focusing suffers from an inherent ambiguity due to which the same non-maximum contrast value represents both an underfocus position and the corresponding overfocus position of the sample. Dithering of the translation stage can typically be used to resolve this ambiguity. However, such dithering may disadvantageously slow down the determination of the actual defocus values needed to implement the corresponding contrast-based autofocus algorithm. For comparison, any such ambiguity is beneficially absent in the plots 802 and 804, each of which is a monotonous function of the defocus. In some examples, each of the plots 802 and 804 can be well approximated by a respective linear function.

Upon completion of the method 700, a plurality of calibration graphs 800 is obtained, with each of such calibration graphs corresponding to a different respective relative axial optical orientation of the optical filter 320 and the pixelated photodetector 380. Different ones of such calibration graphs 800 typically differ from one another in one or more of the following parameter values: (i) slope values of the respective plots 802; (ii) slope values of the respective plots 804; (iii) offset values of the respective plots 802; and (iv) offset values of the respective plots 804. In some examples, each of the calibration graphs 800 is converted into a corresponding calibration lookup table (LUT), which is then stored in a non-transitory computer-readable medium accessible from or via the computing device 110. In some additional examples, each of such calibration graphs 800 is parameterized using a linear approximation, and the resulting sets of parameters are saved in the memory.

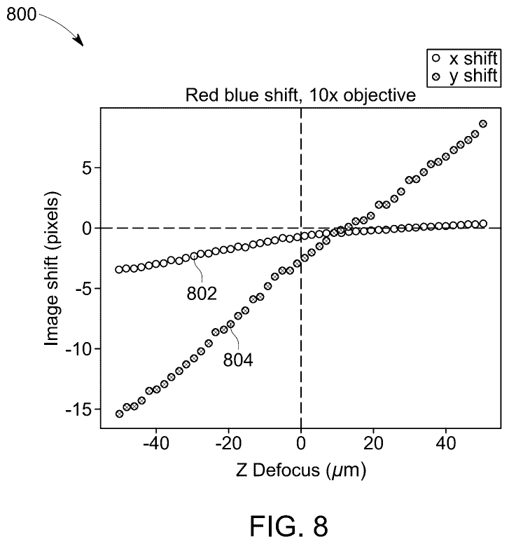

FIG. 9 is a flowchart of an autofocus method 900 implemented in the optical system 100 according to some examples. Startup operations of the method 900 include loading the sample 130 under test (SUT) into the sample holder 252 coupled to the stage 250. The SUT 130 can be substantially any sample including a feature that is sufficient to enable the cross-correlation analysis described above in reference to Eqs. (1)-(5) or a functional equivalent thereof.

The method 900 includes selecting a relative axial optical orientation of the optical filter 320 and the pixelated photodetector 380 (in a block 902). Such relative axial optical orientation can be changed, e.g., as described above in reference to the block 702 of the method 700 (FIG. 7). In some examples, the relative optical orientation whose calibration graph 800 has one or more of the following features may be selected in the block 902: (i) approximately equal slopes of the respective plots 802, 804; (ii) approximately maximum slope of one of the respective plots 802, 804; and (iii) approximately zero value of one or both of the offsets of the respective plots 802, 804. In some examples, the block 902 is optional and is omitted. In the latter case, the a priori (e.g., factory set) relative axial optical orientation of the optical filter 320 and the pixelated photodetector 380 is used as is, without any changes.

The method 900 also includes the computing device 110 loading the pertinent calibration LUT into the cache memory (in a block 904). The pertinent calibration LUT is the LUT corresponding to the relative axial optical orientation selected in the block 902 or to the a priori relative optical orientation when the block 902 is omitted. A plurality of calibration LUTs from which the pertinent calibration LUT is retrieved may be previously generated using the above-described calibration method 700. Operations of the block 904 further include the computing device 110 starting the autofocus function of the optical system 100.

The method 900 also includes the computing device 110 determining the R-B shift vector (Δx, Δy) (in a block 906). Operations of the block 906 include the computing device 110 operating the optical system 100 to acquire an image of the SUT 130. The operations of the block 906 further include (i) reading out a respective pair of R and B sub-images of the image acquired by the pixelated photodetector 380 by selectively addressing the R and B pixel sets thereof and (ii) subjecting such pair of R and B sub-images to image processing with the computing device 110 to determine the corresponding value of the shift vector (Δx, Δy). In some examples, the image processing in the block 906 is performed by the computing device 110 in accordance with Eqs. (1)-(5).

The method 900 also includes the computing device 110 determining a defocus value (in a block 908). The defocus value is determined using the calibration LUT of the block 904 by querying that LUT with the value of the shift vector (Δx, Δy) determined in the block 906.

The method 900 also includes the computing device 110 controlling the actuation of the stage 250 (in a block 910). Operations of the block 910 include the computing device 110 configuring the stage 250 to translate the SUT 130 along the Z-coordinate axis by a distance equal to the defocus value determined in the block 908. Note that the sign of the defocus value indicates the direction, +Z or −Z, in which the stage 250 will translate the SUT 130. This translation substantially cancels the present defocus and brings the SUT 130 back into focus for proper imaging in the optical microscope 120.

It should be noted that the above-described operations of the blocks 906, 908, and 910 may typically be run in parallel to the regular imaging operations of the corresponding optical microscope or probe, without interfering with those imaging operations. As already indicated above, when the SUT 130 is nearly in focus, the camera 220 will operate to continuously capture a sequence of substantially true-color images of the SUT 130 corresponding to homogeneous white-light illumination conditions.

The method 900 also includes the computing device 110 determining whether to quit the autofocus function (in a decision block 912). In various examples, a decision to quit may be prompted by the user 102 or by the completion of the intended set of imaging or observation operations on the SUT 130. When it is determined that the autofocus function is not to be stopped (“No” at the decision block 912), the processing of the method 900 is directed back to the block 906. When it is determined that the autofocus function is to be stopped (“Yes” at the decision block 912), the processing of the method 900 is terminated. In some examples, the method 900 may run in parallel with one or more other sample inspecting processes within a spectroscopy system. For example, in an FTIR system, the sample position may be adjusted while inspecting the sample using the IR beam or navigating the sample in the visible light range using the optical microscope. Since the combined light beams for autofocusing produce essentially white illumination, the autofocusing process of method 900 does not interfere with the usage of the FTIR spectroscopy system.

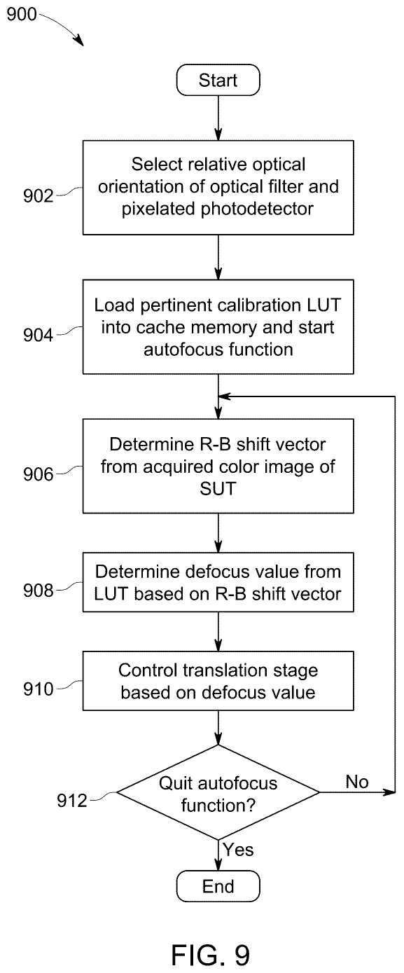

FIG. 10 is a block diagram illustrating a plan view of a multicolor LED assembly 1000 used in the light source of optical microscope 120 according to some examples. The multicolor LED assembly 1000 includes four LED panels arranged side by side to form a substantially square overall shape. The four LED panels include a red LED panel 1002, a first green LED panel 1004, a blue LED panel 1006, and a second green panel LED 1008. The LED panels 1002-1008 are arranged in a basic Bayer pattern. In the example shown, the LED panels 1002-1008 have identical rectangular or square shapes. In some examples, the overall size of the multicolor LED assembly 1000 is 1×1 inch². In some other examples, smaller overall sizes of the multicolor LED assembly 1000 can also be used. In such examples, a set of beam expander optics can be used to beamform the light emitted by the LED assembly 1000 into a beam of a desired size and spatial configuration. In some examples, one of the green LED panels 1004, 1008 is replaced by a white LED panel of the same shape.

In one embodiment of the optical microscope 120, the multicolor LED assembly 1000 is inserted into the optics 300 or 301 in place of the optical filter 320 (also see FIGS. 3A-3B). In such an embodiment, the light source 302 or 303 and the optical filter 320 are absent (removed). In some examples, the multicolor LED assembly 1000 is mounted on the motorized rotation stage 326 (FIG. 3B) that performs rotations of the LED assembly about the X-coordinate axis in response to a corresponding control signal received from the computing device 110.

A person of ordinary skill in the pertinent art will readily understand how to calibrate the autofocus function of the optical microscope 120 having the multicolor LED assembly 1000 using a correspondingly modified method 700, without any undue experimentation. The resulting calibration data can then be used to implement the corresponding embodiment of the autofocus method 900 in a relatively straightforward manner.

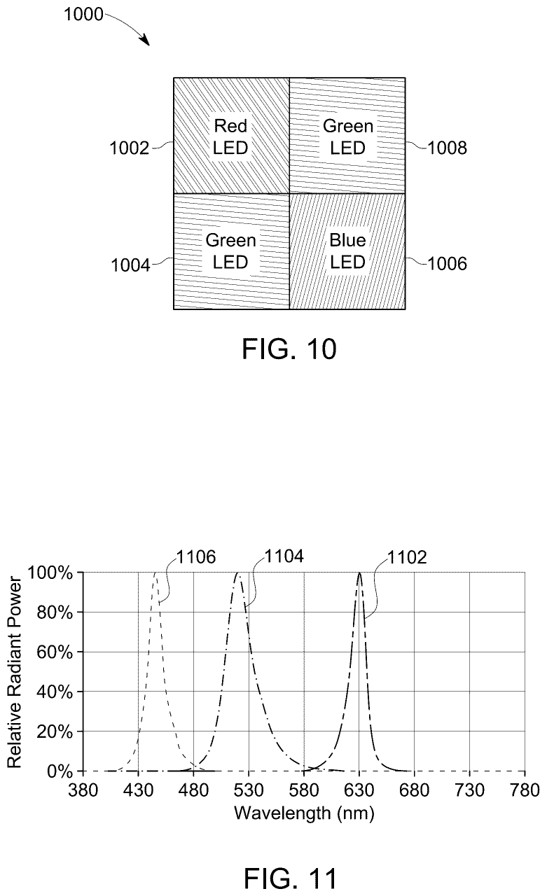

FIG. 11 graphically illustrates spectral characteristics of the multicolor LED assembly 1000 according to one example. Therein, a curve 1102 represents the spectrum of light emitted by the red LED panel 1002. A curve 1104 represents the spectrum of light emitted by the first and second green LED panels 1004, 1008. A curve 1106 represents the spectrum of light emitted by the blue LED panel 1006.

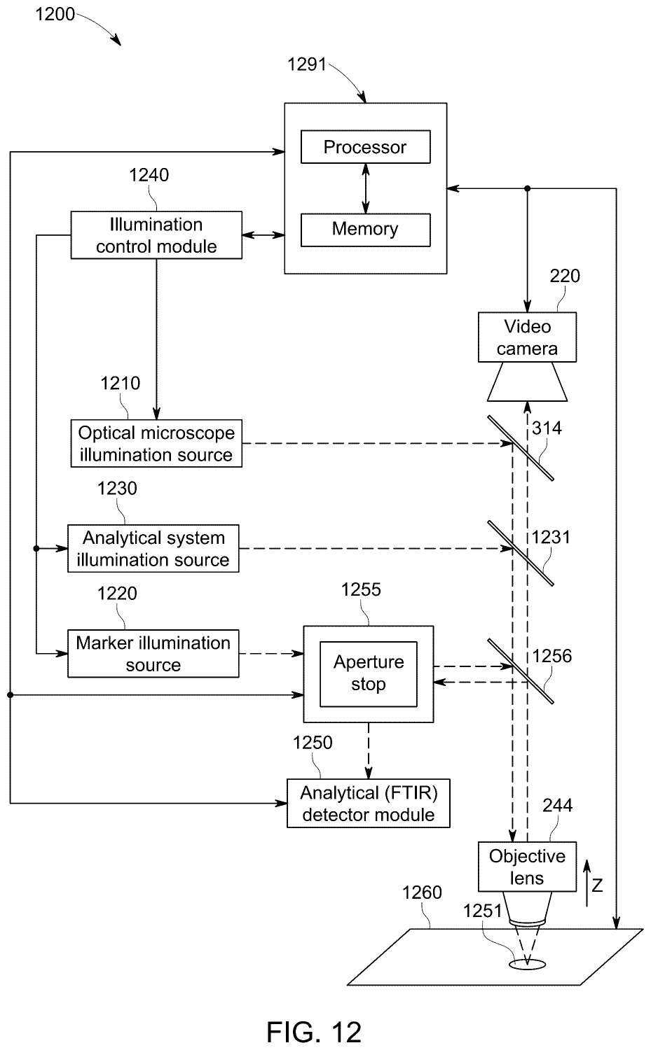

FIG. 12 is a block diagram illustrating an optical system 1200 in which at least some embodiments can be practiced. The optical system 1200 includes an optical microscope and a Fourier-transform infrared (FTIR) spectrometer integrated into a single system. The optical microscope integrated into the optical system includes some of the same components as the above-described optical microscope 120. The description of those components is not repeated here. Instead, the below description of the optical system 1200 primarily focuses on the additional features and capabilities provided by the optical system 1200.

In the example shown, the optical microscope integrated into the optical system 1200 includes an optical microscope illumination source 1210, the beam splitter 314, the objective lens 244, and the camera 220. In one example, the optical microscope illumination source 1210 includes one of the above-described light sources, such as the light source 230₁, 302, or 303. Light generated by the optical microscope illumination source 1210 is directed toward the objective lens 244 after being redirected by the beam splitter 314. The objective lens 240 directs the light toward a sample 1251 positioned on a stage 1260. A portion of the light reflected from the sample 1251 passes through the objective lens 244 and is received by the camera 220. On its way to the camera 220, the received light may also pass one or more additional beam splitters, for example, beam splitters 1256 and 1231.

In the example shown, the FTIR spectrometer integrated into the optical system 1200 includes an analytical illumination source 1230, the beam splitter 1231, a marker aperture stop 1255, and an analytical (FTIR) detector module 1250. In operation, probe light (e.g., in the NIR-IR wavelength range between approximately 800 nm and approximately 10⁴ nm) generated by the analytical illumination source 1230 is directed sequentially to the beam splitter 1231, the beam splitter 1256, the objective lens 244, and the sample 1251. The probe light reflected back from the sample 1251 sequentially impinges on the objective lens 244, the beam splitter 1256, the marker aperture stop 1255, and reaches the analytical (FTIR) detector module 1250. The maker aperture stop 1255 includes an adjustable aperture, with the size of the aperture being controlled by an illumination control module 1240 and/or a computing device 1291. Based on the spectral data (interferograms) acquired with the analytical (FTIR) detector module 1250, infrared spectra of the sample 1251 can be computed by the computing device 1291, and then the composition of the sample 1251 can be analyzed based on the infrared spectra in a spatially resolved manner. The size of the aperture in the marker aperture stop 1255 is typically selected to limit the sample arca from which the reflected probe light can reach the analytical (FTIR) detector module 1250. In other words, the selected size of the aperture determines the spatial resolution of the FTIR spectrometer.

The optical system 1200 also includes a marker illumination source 1220. Marker light generated by the marker illumination source 1220 reaches the sample 1251 after sequentially passing the marker aperture stop 1255, the beam splitter 1256, and the objective lens 244. Part of the marker light reflected from the sample 1251 is received by the camera 220 after passing through the beam splitters 1256, 1231, and 340. In one example, the marker light generated by the marker illumination source 1220 has a narrower bandwidth compared to the light generated by the optical microscope illumination source 1210. For example, the wavelength bandwidth of the light generated by the marker illumination source 1220 can be less than 100 nm, less than 50 nm, or even less than 30 nm. In some examples, the light generated by the marker illumination source 1220 is blue light.

The use of the blue marker light can beneficially reduce the deleterious effects of external light sources on acquiring the aperture marker images. For example, when the sample 1251 is only illuminated by the marker illumination source 1220, the corresponding image acquired by the camera 220 includes a high-intensity region corresponding to the portion of the sample surface illuminated by the marker light passing through the aperture if the marker aperture stop 1255. The high-intensity region in such image is referred to as an aperture marker. The shape and size of the aperture marker in the image depend on the shape and size of the aperture used in the marker aperture stop 1255, the optical configuration of the optical system 1200, and the position of the sample 1251 with respect to the objective lens 244. The aperture marker in the acquired image can be used to mark the region of the sample that is being analyzed by the FTIR spectrometer. As such, when both the optical microscope illumination source 1210 and the marker illumination source 1220 are turned on, the aperture marker can be used to select different regions of interest in the sample 1251 for the FTIR acquisition.

In one example, the focal plane of the optical microscope and the FTIR spectrometer integrated into the optical system 1200 is the same, which enables proper visualization of various regions of the sample 1251 for FTIR analysis. Ideally, the focal plane should be substantially at the sample surface. Towards that goal, the position of the sample 1251 can be adjusted, e.g., by translating the sample 1251 along the Z-coordinate axis. In some examples, such adjustments are performed using the autofocus method 900. In some examples, the autofocus method is implemented using the computing device 1291.

It should be noted that the operations of the blocks 906, 908, and 910 of the method 900 implemented with the computing device 1291 may typically be run in parallel to the regular FTIR-acquisition and imaging operations of the optical system 1200, without interfering with those operations. As explained above, when the sample 1251 is nearly in focus, the camera 220 will operate to continuously capture a sequence of substantially true-color images of the sample 1251 representing effective homogeneous white-light illumination with the optical microscope illumination source 1210.

FIG. 13 is a block diagram illustrating a computing device 1300 used in the optical systems 100, 1200 according to some examples. In various examples, each of the optical systems 100, 1200 may include a single computing device 1300 or multiple computing devices 1300. In some examples, the computing device 1300 implements the computing device 110 (also see FIG. 1) or the computing device 1291 (also see FIG. 12). In various examples, an instance of the computing device 1300 can be used to implement the method 700 and/or the method 900 in the corresponding optical system 100 or 1200.

The computing device 1300 of FIG. 13 is illustrated as having a number of components, but any one or more of these components may be omitted or duplicated, as suitable for the application and setting. In some embodiments, some or all of the components included in the computing device 1300 may be attached to one or more motherboards and enclosed in a housing. In some embodiments, some of those components may be fabricated onto a single system-on-a-chip (SoC) (e.g., the SoC may include one or more electronic processing devices 1302 and one or more storage devices 1304).

The computing device 1300 includes a processing device 1302 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 1302 may include one or more digital signal processors (DSPs), application-specific integrated circuits (ASICs), central processing units (CPUs), graphics processing units (GPUs), server processors, field programmable gate arrays (FPGA), or any other suitable processing devices.

The computing device 1300 also includes a storage device 1304 (e.g., one or more storage devices). In various embodiments, the storage device 1304 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 1304 may include memory that shares a die with the processing device 1302. In some embodiments, the storage device 1304 may include non-transitory computer readable media having instructions thereon that, when executed by one or more processing devices (e.g., the processing device 1302), cause the computing device 1300 to perform any appropriate ones of the methods disclosed herein below or portions of such methods.

The computing device 1300 further includes an interface device 1306 (e.g., one or more interface devices 1306). In various embodiments, the interface device 1306 may include one or more communication chips, connectors, and/or other hardware and software to govern communications between the computing device 1300 and other computing devices. In some embodiments, the interface device 1306 may include circuitry for managing wired communications, such as electrical, optical, or any other suitable communication protocols. For example, the interface device 1306 may include circuitry to support communications in accordance with Ethernet technologies. In some embodiments, the interface device 1306 may support both wireless and wired communication, and/or may support multiple wired communication protocols and/or multiple wireless communication protocols.

The computing device 1300 also includes battery/power circuitry 1308. In various embodiments, the battery/power circuitry 1308 may include one or more energy storage devices (e.g., batteries or capacitors) and/or circuitry for coupling components of the computing device 1300 to an energy source separate from the computing device 1300 (e.g., to AC line power).

The computing device 1300 also includes a display device 1310 (e.g., one or multiple individual display devices). In various embodiments, the display device 1310 may include any visual indicators, such as a heads-up display, a computer monitor, a projector, a touchscreen display, a liquid crystal display (LCD), a light-emitting diode display, or a flat panel display.

The computing device 1300 also includes additional input/output (I/O) devices 1312. In various embodiments, the I/O devices 1312 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment of the optical system 100, various components of the interface devices 1306 and/or I/O devices 1312 can be configured to send and receive suitable control messages, suitable control/telemetry signals, and streams of data. In some examples, the interface devices 1306 and/or I/O devices 1312 include one or more analog-to-digital converters (ADCs) for transforming received analog signals into a digital form suitable for operations performed by the processing device 1302 and/or the storage device 1304. In some additional examples, the interface devices 1306 and/or I/O devices 1312 include one or more digital-to-analog converters (DACs) for transforming digital signals provided by the processing device 1302 and/or the storage device 1304 into an analog form suitable for being communicated to the corresponding components of the optical system 100 or 1200.

According to one example disclosed above, e.g., in the summary section and/or in reference to any one or any combination of some or all of FIGS. 1-13, provided is an optical system comprising: a wavelength-sensitive photodetector; a light source configured to output a first light beam of a first wavelength range and a second light beam of a second wavelength range; optics configured to illuminate a portion of a sample with the first and second light beams from different directions of incidence and project an image of at least a part of the illuminated portion of the sample onto the wavelength-sensitive photodetector; and a computing device including a non-transitory computer-readable medium for storing instructions and an electronic processor, wherein by executing the instructions with the processor, the computing device is configured to determine a degree of defocus based on a first sub-image of the projected image and a second sub-image of the projected image, the first sub-image being formed with light within the first wavelength range detected by the wavelength-sensitive photodetector, the second sub-image being formed with light within the second wavelength range detected by the wavelength-sensitive photodetector.

In some examples of the above system, the optics is configured to illuminate the illuminated portion of the sample with spatially overlapped light beams including the first and second light beams.

In some examples of any of the above systems, the computing device includes an electronic processor and a non-transitory computer-readable medium storing instructions, and wherein the computing device is configured to determine the degree of defocus by executing the instructions in the electronic processor.

In some examples of any of the above systems, the system further comprises an adjustable element configured to translate the sample relative to a focal plane of the optics, wherein the computing device is further configured to control the adjustable element based on the degree of defocus.

In some examples of any of the above systems, the adjustable element includes a translation stage to which the sample is coupled.

In some examples of any of the above systems, the light source is configured to output a plurality of spatially separated light beams including the first light beam and the second light beam.

In some examples of any of the above systems, an angle between the first light beam and the second light beam at the illuminated sample portion is greater than 45 degrees.

In some examples of any of the above systems, the first light beam and the second light beam are spatially separated at an aperture stop of the light source.

In some examples of any of the above systems, the first light beam and the second light beam combine at the illuminated sample portion to produce substantially white-light illumination thereat.

In some examples of any of the above systems, the spatially separated light beams combine into substantially white light when spatially overlapped.

In some examples of any of the above systems, the first wavelength range is between 430 nm and 485 nm; and wherein the second wavelength range is between 610 nm and 700 nm.

In some examples of any of the above systems, the first wavelength range and the second wavelength range do not overlap.

In some examples of any of the above systems, the first wavelength range and the second wavelength range spectrally overlap by less than 50 nm.

In some examples of any of the above systems, the light source comprises: a broadband source; and an optical filter configured to filter light generated by the broadband source to produce the first light beam and the second light beam.

In some examples of any of the above systems, the optical filter is in a Fourier plane of the optics.

In some examples of any of the above systems, the optical filter includes a plurality of tiles including: a first tile configured to pass light within the first wavelength range and substantially stop light within the second wavelength range; and a second tile configured to pass light within the second wavelength range and substantially stop light within the first wavelength range.

In some examples of any of the above systems, the optical filter includes a short-pass filter and a long-pass filter; and wherein a cut-off wavelength of the short-pass filter and a cut-on wavelength of the long-pass filter are spectrally aligned with one another and with a characteristic wavelength of the wavelength-sensitive photodetector.

In some examples of any of the above systems, the first tile is a short-pass filter to visible light; wherein the second tile is a long-pass filter to visible light; and wherein a cut-off wavelength of the short-pass filter is spectrally aligned with a cut-on wavelength of the long-pass filter to within 10 nm (or 5 nm, or 1 nm).

In some examples of any of the above systems, each of the cut-off wavelength and the cut-on wavelength is spectrally aligned with a characteristic wavelength of the wavelength-sensitive pixelated photodetector to within 10 nm (or 5 nm, or 1 nm), the characteristic wavelength corresponding to a spectral intersection of a spectral response curve of a first array of pixels sensitive to light within the first wavelength range and a spectral response curve of a second array of pixels sensitive to light within the second wavelength range.

In some examples of any of the above systems, the light source includes an aperture stop; and wherein the optical filter is located at the aperture stop.

In some examples of any of the above systems, the system further comprises a rotation stage configured to rotate the optical filter about an optical axis of the optics.

In some examples of any of the above systems, the light source comprises a multicolor light emitting diode (LED) assembly including a first LED panel configured to emit the first light beam and a second LED panel configured to emit the second light beam.

A Fourier-transform infrared (FTIR) system including any of the above systems, wherein the FTIR system obtains an interferogram corresponding to an area within the illuminated portion of the sample.

According to another example disclosed above, e.g., in the summary section and/or in reference to any one or any combination of some or all of FIGS. 1-13, provided is a method for providing support to an optical system, the method comprising: generating a first light beam of a first wavelength range and a second light beam of a second wavelength range; illuminating a sample portion with the first light beam and the second light beam from different directions of incidence; projecting an image of at least a part of the illuminated sample portion onto a wavelength-sensitive photodetector; obtaining a first sub-image and a second sub-image from the image detected by the wavelength-sensitive photodetector, wherein the first sub-image is formed with light within the first wavelength range, and wherein the second sub-image is formed with light within the second wavelength range; and determining a degree of defocus based on the first sub-image and the second sub-image.

In some examples of the above method, determining the degree of defocus based on the first sub-image and the second sub-image comprises: determining a relative shift between the first sub-image and the second sub-image; and estimating the degree of defocus based on the relative shift.

In some examples of any of the above methods, the estimating the degree of defocus based on the relative shift comprises querying a lookup table using the determined relative shift, the lookup table having stored therein calibration data that provide a mapping between relative shift values and degree-of-defocus values.

In some examples of any of the above methods, determining the relative shift comprises applying cross-correlation analysis to the first sub-image and the second sub-image.

In some examples of any of the above methods, the method further comprises controlling an adjustable element of the optical system to adjust a relative position between the sample and a focal plane of the optics based on the degree of defocus.

In some examples of any of the above methods, the method further comprises automatically adjusting the relative position between the sample and the focal plane of the optics while probing the illuminated sample region with probe light in near infrared and/or infrared wavelength range.

A non-transitory computer-readable medium storing instructions that, when executed by the computing device, cause the computing device to perform operations comprising any one of the above methods.

Unless explicitly stated otherwise, each numerical value and range should be interpreted as being approximate as if the word “about” or “approximately” preceded the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

What is claimed is:

1. An optical system, comprising:
a wavelength-sensitive photodetector;
a light source configured to output a first light beam of a first wavelength range and a second light beam of a second wavelength range;
optics configured to illuminate a portion of a sample with the first and second light beams from different directions of incidence and project an image of at least a part of the illuminated portion of the sample onto the wavelength-sensitive photodetector; and
a computing device including a non-transitory computer-readable medium for storing instructions and an electronic processor, wherein by executing the instructions with the processor, the computing device is configured to determine a degree of defocus based on a first sub-image of the projected image and a second sub-image of the projected image, the first sub-image being formed with light within the first wavelength range detected by the wavelength-sensitive photodetector, the second sub-image being formed with light within the second wavelength range detected by the wavelength-sensitive photodetector.

2. The system of claim 1, further comprising an adjustable element configured to translate the sample relative to a focal plane of the optics,
wherein the computing device is further configured to control the adjustable element based on the degree of defocus.

3. The system of claim 2, wherein the adjustable element includes a translation stage to which the sample is coupled.

4. The system of claim 1, wherein an angle between the first light beam and the second light beam at the illuminated sample portion is greater than 45 degrees.

5. The system of claim 1, wherein the first light beam and the second light beam are spatially separated at an aperture stop of the light source.

6. The system of claim 5, wherein the first light beam and the second light beam combine at the illuminated sample portion to produce substantially white light illumination thereat.

7. The system of claim 1,
wherein the first wavelength range is between 430 nm and 485 nm; and
wherein the second wavelength range is between 610 nm and 700 nm.

8. The system of claim 1, wherein the first wavelength range and the second wavelength range spectrally overlap by less than 50 nm.

9. The system of claim 1, wherein the light source comprises:
a broadband source; and
an optical filter configured to filter light generated by the broadband source to produce the first light beam and the second light beam.

10. The system of claim 9,
wherein the optical filter includes a short-pass filter and a long-pass filter; and
wherein a cut-off wavelength of the short-pass filter and a cut-on wavelength of the long-pass filter are spectrally aligned with one another and with a characteristic wavelength of the wavelength-sensitive photodetector.

11. The system of claim 9,
wherein the light source includes an aperture stop; and
wherein the optical filter is located at the aperture stop.

12. The system of claim 9, further comprising a rotation stage configured to rotate the optical filter about an optical axis of the optics.

13. The system of claim 1, wherein the light source comprises a multicolor light emitting diode (LED) assembly including a first LED panel configured to emit the first light beam and a second LED panel configured to emit the second light beam.

14. A Fourier-transform infrared (FTIR) system including the optical system of claim 1, wherein the FTIR system is configured to obtain an interferogram corresponding to an area within the illuminated portion of the sample.

15. A method for providing support to an optical system, the method comprising:
generating a first light beam of a first wavelength range and a second light beam of a second wavelength range;
illuminating a sample portion with the first light beam and the second light beam from different directions of incidence;
projecting an image of at least a part of the illuminated sample portion onto a wavelength-sensitive photodetector;
obtaining a first sub-image and a second sub-image from the image detected by the wavelength-sensitive photodetector, wherein the first sub-image is formed with light within the first wavelength range, and wherein the second sub-image is formed with light within the second wavelength range; and
determining a degree of defocus based on the first sub-image and the second sub-image.

16. The method of claim 15, wherein determining the degree of defocus based on the first sub-image and the second sub-image comprises:
determining a relative shift between the first sub-image and the second sub-image; and
estimating the degree of defocus based on the relative shift.

17. The method of claim 16, wherein estimating the degree of defocus based on the relative shift comprises querying a lookup table using the determined relative shift, the lookup table having stored therein calibration data that provide a mapping between relative shift values and degree-of-defocus values.

18. The method of claim 15, further comprising controlling an adjustable element of the optical system to adjust a relative position between the sample and a focal plane of the optics based on the degree of defocus.

19. The method of claim 18, further comprising automatically adjusting the relative position between the sample and the focal plane of the optics while probing the illuminated sample region with probe light in near infrared and/or infrared wavelength range.

20. A non-transitory computer-readable medium storing instructions that, when executed by the computing device, cause the computing device to perform operations comprising the method of claim 15.
